(19) United States
(12) Patent Application Publication
(10) Pub. No.: US 2004/0024651 A1
(43) Pub. Date: Feb. 5, 2004

(54) Systems and methods for shopping by computer

(76) Inventors: John W. Daniel, Athens, GA (US); Jerome D. Jackson, Falls Church, VA (US)

Correspondence Address: JEROME D. JACKSON (JACKSON PATENT LAW OFFICE), 211 N. UNION STREET, SUITE 100, ALEXANDRIA, VA, 22314, US

(21) Appl. No.: 10/330,014

(22) Filed: Dec. 27, 2002

Related U.S. Application Data
(60) Provisional application No. 60/342,735, filed on Dec. 28, 2001.

(51) Int. Cl. G06F 17/60

(52) U.S. Cl. 705/26

(57) ABSTRACT

Disclosed are systems and methods for shopping by computer.

This Application claims the benefit of U.S. Application Serial No. 60/342,735 of John W. DANIEL and Jerome D. JACKSON filed Dec. 28, 2001 for SYSTEMS AND METHODS FOR SHOPPING BY COMPUTER, the contents of which are herein incorporated by reference.

### BACKGROUND OF THE INVENTION

1. Field of the Invention

This invention relates generally to systems and methods for shopping by computer and, more particularly, to systems and methods for ordering products using a computer located outside of a store.

2. Description of Related Art

A person desiring to purchase a product on-line may attempt to find a web site through which the product may be purchased. One may search for such a site by using an Internet Search engine such as one provided by America Online™, Yahoo™, AltaVista™, WebCrawler™, Lycos™, Excite™, etc. The search process, however, can be both time consuming and expensive, and may in fact fail to locate a site from which the product may be purchased.

### SUMMARY OF THE INVENTION

It is an object of the present invention to provide systems and methods for shopping by computer.

To achieve this and other objects of the present invention, there is a method in a system including a first building, and an interface including an output device. The method comprises detecting selection of a first instance of a first item by a first person in the first building; and generating, responsive to the detecting step, a first signal for display by the output device at a time when the output device is displaced from the first building, the first signal representing a plurality of items, including the first item, with respective directions for purchasing the items.

According to another aspect of the present invention, there is a processing system in a system including a first building, and an interface including an output device. The processing system comprises a generator, responsive to detecting selection of a first instance of a first item by a first person in the first building, that generates a first signal for display by the output device at a time when the output device is displaced from the first building, the first signal representing a plurality of items, including the first item, with respective directions for purchasing the items.

According to yet another aspect of the present invention, there is a processing system in a system including a first building, and an interface including an output device. The processing system comprises means for detecting selection of a first instance of a first item by a first person in the first building; and means for generating, responsive to the detecting step, a first signal for display by the output device at a time when the output device is displaced from the first building, the first signal representing a plurality of items, including the first item, with respective directions for purchasing the items.

### BRIEF DESCRIPTION OF THE DRAWINGS

FIG. 1 is a diagram showing a system for on-line shopping in accordance with a first preferred embodiment of the present invention.

FIG. 2 is a flow chart showing a process performed in the first preferred system.

FIG. 3 is a view emphasizing a part of a store in the system shown in FIG. 1.

FIG. 4 is a view of a home in the system shown in FIG. 1.

FIG. 5 is a data flow diagram showing a process performed in a computer system in the first preferred system.

FIG. 6 is a view emphasizing a computer display generated in the home shown in FIG. 4.

FIG. 7 is a view emphasizing another computer display generated in the home shown in FIG. 4.

FIG. 8 is a block diagram emphasizing another part of the store.

FIG. 9 is another block diagram emphasizing other parts of the store.

FIG. 10 is a diagram showing data structures generated by, and sent from, a retail store in the first preferred system.

FIG. 11 is a data flow diagram for describing a process performed in the first preferred system.

FIG. 12 is a flowchart for describing the process that is the subject of FIG. 11.

FIG. 13 is a diagram showing a data structure generated by the process described in connection with FIGS. 11 and 12.

FIG. 14 is a diagram showing a data structure storing information about a retailer.

FIGS. 15A and 15B are a diagram showing a system for on-line shopping in accordance with a second preferred embodiment of the present invention.

FIG. 16 is a data flow diagram for describing a process performed in the second preferred system.

FIG. 17 is a view emphasizing a computer display generated in a home in the second preferred system.

FIG. 18 is another data flow diagram for describing a process performed in the second preferred system.

FIG. 19 is a diagram showing a system for on-line shopping in accordance with a third preferred embodiment of the present invention.

FIG. 20 is a view emphasizing a part of a store in the system shown in FIG. 19.

FIG. 21 is a diagram of a computer system in the store shown in FIG. 20.

FIGS. 22A and 22B are a diagram emphasizing certain aspects of the system shown in FIG. 21.

FIG. 23 is a view emphasizing a part of a store in accordance with a fourth embodiment of the present invention.

FIG. 24 is a view emphasizing a computer display generated in a home in the fourth preferred system.

FIG. 25 is a view emphasizing another computer display generated in the home in the fourth preferred system.

FIG. 26 is a data flow diagram for describing a process performed in the fourth preferred system.

FIG. 27 is a flowchart for describing the process that is the subject of FIG. 26.

FIG. 28 is a diagram showing a data structure processed by the process described in connection with FIGS. 26 and 27.

The accompanying drawings, which are incorporated in and which constitute a part of this specification, illustrate embodiments of the invention. Throughout the drawings, corresponding parts are labeled with corresponding reference numbers.

### DESCRIPTION OF THE PREFERRED EMBODIMENTS

First Preferred Embodiment

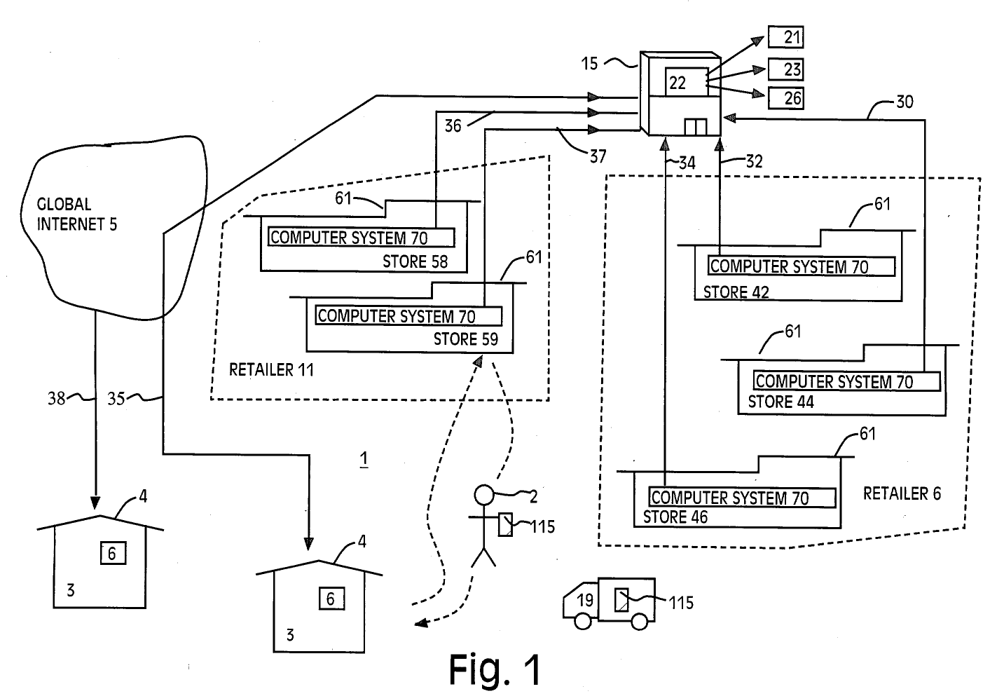

FIG. 1 shows system 1 including retailers 6 and 11 in mutual competition. Retailer 6 includes store 42, store 44, and store 46. Retailer 11 includes the CHOICE department store chain. Retailer 11 includes store 58, and store 59. Store 59 includes computer system 70 under roof structure 61.

Person 2 resides in home 3. Person 2 travels to a retail store, inspects a product in the store, purchases the product, and personally transports the product back to home 3. For example, person 2 visits store 59. While in store 59, person 2 inspects various socks offered for sale. Influencing the decision of person 2 may be the shape, size, and color of the socks, as well as the product packaging of the socks. Person 2 then purchases socks package 115. Socks package 115 contains a pair of Super brand size 10, black socks.

Computer system 70 in store 59 detects the purchase of socks package 115 by person 2, and sends purchase data identifying the purchase to site 15. Site 15 is owned by a business entity different from retailer 11. Site 15 is in a building containing computer 22 system. Computer 22 system receives the purchase data from signal path 37.

Home 3 includes computer system 6 under roof structure 4. Several weeks after visiting store 59, person 2 operates personal computer in home 6. Personal computer 6 acts to receive and display a Hypertext Markup Language (HTML) file from site 15, via Internet 5 and signal path 35. The HTML file includes a menu of products that may be purchased on-line. The menu includes products previously purchased by person 2, including socks package 115.

Person 2 views the HTML file and, in response to this viewing, selects a product for purchase using a mouse or keyboard of computer 6. Site 15 detects this product selection and consummates a purchase transaction with consumer 2 by, for example, processing credit card information for person 2.

Site 15 then generates a signal to ultimately cause personnel to deliver socks package 115 to home 3, via delivery van 19 operated by a private courier service, government mail, or a retailer. Site 15 also adds a fraction of the transaction price to account 23, which is effectively a sales reward owed to retailer 11. In other words, in reliance on signals generated in home 3, site 15 compensates retailer 11 for the on-line purchase of a product, when the on-line purchase was electronically facilitated, or enabled, by a physical visit to a store of retailer 11.

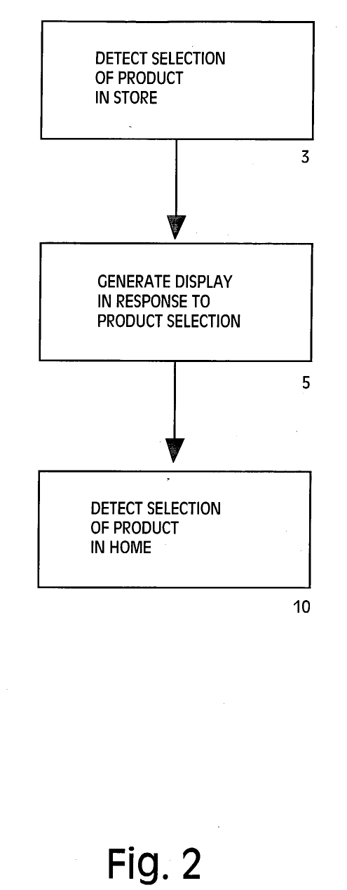

FIG. 2 is a flow chart showing a process performed by circuitry in the first preferred system. System 1 detects selection of a product in a retail store, by processing a signal from a barcode reader or cash register keyboard. In the first preferred system, this signal is also used to calculate an amount due from the consumer. (step 3). Computer system 22 in site 15 generates a display in response to the product selection, detected in step 3. (step 5). Days, weeks, or months later, system 1 detects selection of a product for purchase from the home, by processing a signal from the mouse or keyboard of a personal computer. (step 10).

The spatial locations on the drawing sheet of FIG. 1 does not indicate geographic locations. Stores within a particular retailer may be widely separated geographically, and stores of different retailers may be relatively close. For example, store 58 may be in the same neighborhood as store 44, or home 3.

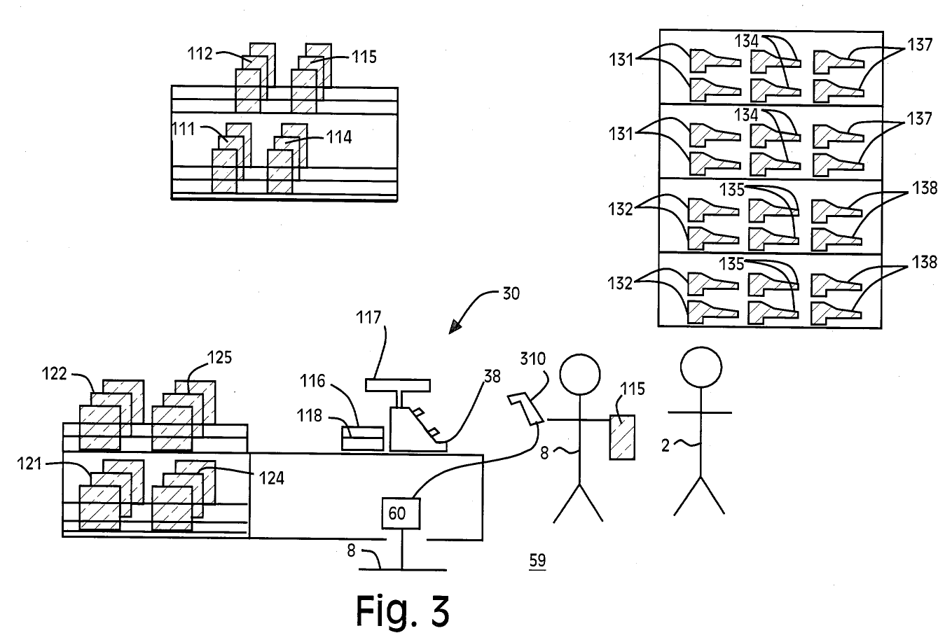

FIG. 3 shows retail department store 59 in more detail. Store 59 includes various products supported by various shelves and display racks. Store 59 includes Super brand socks package 111 containing size 8 blue socks; Super brand socks package 112 containing size 10 blue socks; Super brand socks package 114 containing size 8 black socks; and Super brand socks package 115 containing size 10 black socks.

Each package of socks 115 has a common Universal Product Code (UPC) symbol, which is a group of parallel lines encoding a number typically called a “bar code.” This number is part of a product identification system documented by the Uniform Code Council, Inc., Dayton, Ohio. The first digit is a number system character, which in this case is 0. The next five digits are a manufacturer ID. The next 5 digits are an item number. The last digit is a check digit. UPC product code 0 17055 00007 3 uniquely identifies Super brand size 10 black socks package.

Each package of socks 114 has a common UPC symbol encoding a product code (0 17055 00031 3) uniquely identifying Super brand size 8 black socks.

Each package of socks 112 has a common UPC symbol encoding a product code (0 17055 00024 6) uniquely identifying Super brand size 10 blue socks.

Each package of socks 111 has a common UPC symbol encoding a product code (0 17055 00005 2) uniquely identifying Super brand size 8 blue socks.

Super brand T-shirt package 121 contains a size 38 white T-shirt; Super brand T-shirt package 122 contains a size 42 white T-shirt; Super brand T-shirt package 124 contains a size 38 brown T-shirt; and Super brand T-shirt package 125 contains a size 42 brown T-shirt.

Each T-shirt package 121 has a common UPC symbol encoding a product code (0 17055 00135 5) uniquely identifying a Super brand size 38 white T-shirt.

Each T-shirt package 122 has a common UPC symbol encoding a product code (0 17055 00136 2) uniquely identifying a Super brand size 42 white T-shirt.

Each T-shirt package 124 has a common UPC symbol encoding a product code (O 17055 00145 7) uniquely identifying a Super brand size 38 brown T-shirt.

Each T-shirt package 125 has a common UPC symbol encoding a product code (O 17055 00146 4) uniquely identifying a Super brand size 42 brown T-shirt.

Shoes 131 are a pair of Acme brand size 7 black wingtip shoes; Shoes 132 are a pair of Acme brand size 10 black wingtip shoes; Shoes 134 are a pair of Acme brand size 8 brown wingtip shoes; and Shoes 135 are a pair of Acme brand size 10 brown wingtip shoes.

Each pair of shoes 131 is associated with a common Universal Product Code (O 17023 00071 4) uniquely identifying Acme brand size 7 black wingtip shoes.

Each pair of shoes 132 is associated with a common Universal Product Code (O 17023 00067 0) uniquely identifying Acme brand size 10 black wingtip shoes.

Each pair of shoes 134 is associated with a common Universal Product Code (O 17023 00065 2) uniquely identifying Acme brand size 8 brown wingtip shoes.

Each pair of shoes 135 is associated with a common Universal Product Code (O 17023 00062 7) uniquely identifying Acme brand size 10 brown wingtip shoes.

Shoes 137 are a pair of Beta brand size 10 black wingtip shoes; and Shoes 138 are a pair of Beta brand size 12 black wingtip shoes.

Each pair of shoes 137 is associated with a common Universal Product Code (O 17105 00031 4) uniquely identifying Acme brand size 10 black wingtip shoes.

Each pair of shoes 138 is associated with a common Universal Product Code (O 17105 00030 2) uniquely identifying Acme brand size 12 black wingtip shoes.

Similarly, respective units of other products in store 59 are associated with a common Universal Product Code, different from Universal Product Codes on units of other products, that uniquely identifies the product. Respective units of a certain product also have a common human readable word label, different from labels on units of other products, that uniquely identifies the certain product with words.

A consumer, such as consumer 2, shops throughout store 59 by inspecting product appearances, reading information on product packages, querying sales personnel to learn additional information about products, etc. Consumer 2 then selects a product such as sock package 115 and gives sock package 115 to salesperson 8. Consumer 2 may present a card for insertion into interface slot 118 of card reader 116. Salesperson 8 scans each selected product using bar code reader 310, or enters the product selection information manually via keyboard 38, allowing checkout station 30 to generate a Universal Product Code for each selected product. Thus, station 30 determines the amount due from consumer 2, and displays the amount due via pole display 117. Station circuitry 60 also sends the Universal Product Code over network cable 8, allowing another computer in store 59 to send a record of the transaction to site 15 via signal path 37. In this Patent Application, the word circuitry encompasses dedicated hardware, and/or programmable hardware, such as a CPU or reconfigurable logic array, in combination with programming data, such as sequentially fetched CPU instructions or programming data for a reconfigurable array.

The transaction record, sent on signal path 37, is a combination of the Universal Product Code of the purchased product and an identification for consumer 2. The identification for consumer 2 may be generated by card reader 116, by reading a personal card presented by consumer 2. The personal card may be a credit card, a debit card, a smart card for storing coupons, or some other type of card containing identification data for the consumer.

Thus, a single scan by barcode reader 310 serves the dual purpose of calculating a price for a product and sending a transaction record to site 15 via signal path 37.

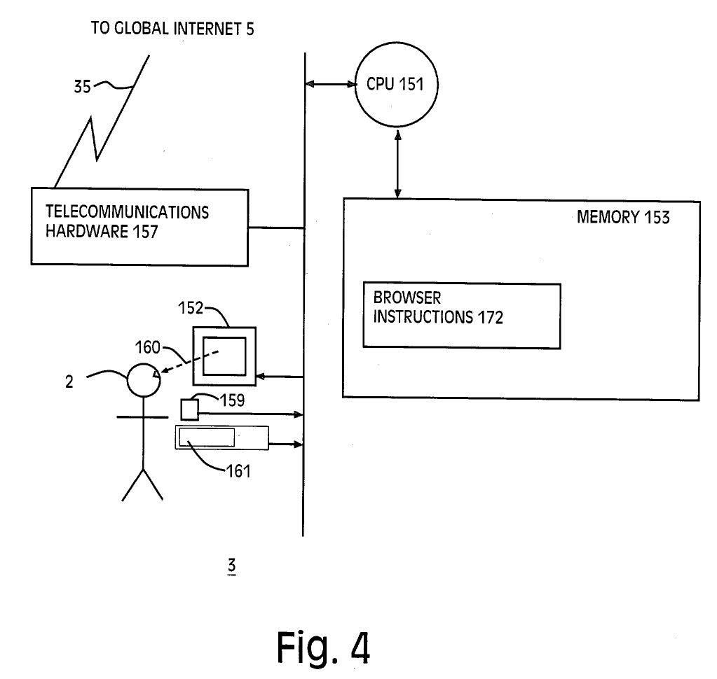

FIG. 4 shows home 3 in more detail. Home 3 includes computer system 6 having CPU 151, CRT display 152, mouse input device 159, keyboard 161, memory 153 for storing programs and data, and telecommunications hardware 157. Memory 153 includes random access memory (RAM) and disk memory.

CRT 152 is an output device and mouse 159 is a type of pointing input device. CRT 152 and mouse 159 together constitute a type of user interface.

Telecommunications hardware 157 may include a modem, PSTN interface circuitry, or T1 connection interface circuitry, for example. Telecommunication hardware 157 could also include a wireless transceiver for satellite communication.

Browser program 172 receives HTML files via global Internet 5 and telecommunications hardware 157. Consumer 2 may select a product for purchase depending on the content of an HTML file displayed on cathode ray tube (CRT) 152.

More specifically, program 172 displays contents of the current HTML file to consumer 2 via CRT 152. Consumer 2 views contents of the displayed file and, in response to the viewed contents, manipulates mouse input device 159 or keyboard 161. In other words, consumer 2 processes light signal 160 from CRT 152 and, in response to contents of light signal 160, generates a type of product selection signal using device 159 or keyboard 161.

Software program 172 receives the selection signal from consumer 2 and, depending on the selection signal, sends a request to receive an additional file related to the selected product, or sends a request to purchase the selected product. Menu selection allowing for the purchase of a product previously purchased by a store visit of consumer 2.

To initiate an on-line shopping session, user 2 causes browser 172 to send a document request message to system 22 in site 15 using HTTP (HyperText Transport Protocol), which is a standard World Wide Web client-server protocol used for the exchange of information between a browser and a Web server. More specifically, browser 172 sends an HTTP “GET” message containing the URL (Universal Resource Locator) “custom-mall.com.” Browser 172 sends this particular URL, “custom-mall.com,” in response to user 2 typing in this URL using keyboard 161, or selecting a particular bookmark using mouse 159.

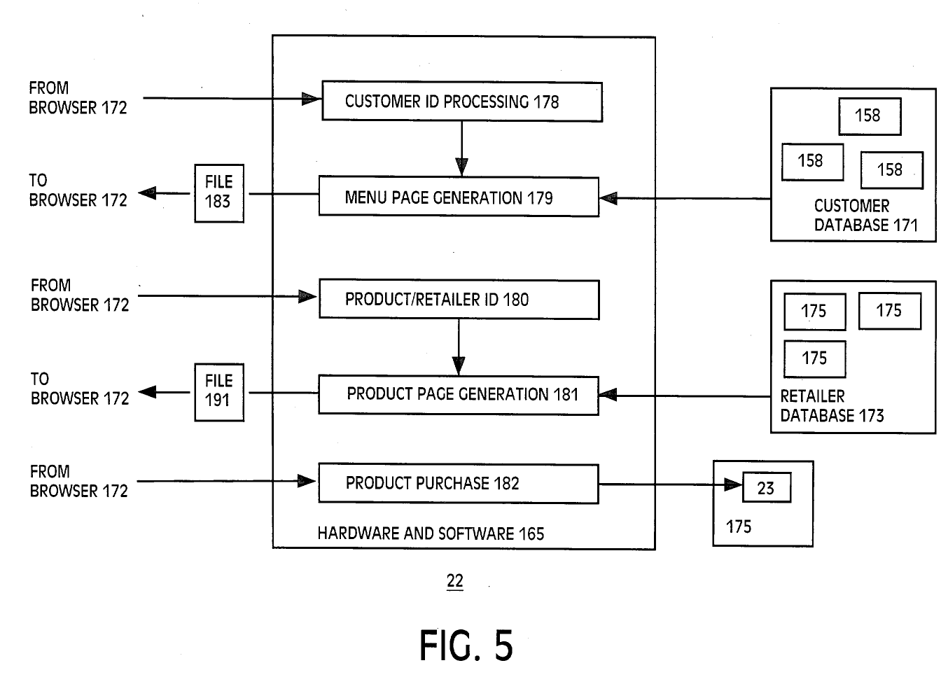

FIG. 5 is a data flow diagram showing a process performed in computer system 22 in site 15. In response to the GET message, customer ID processing instructions 178 obtain a customer ID by attempting to read a cookie from browser 172 to identify customer 2; or, in the alternative, sending an HTML file to browser 172, allowing customer 2 to type in identification information using keyboard 161. Instructions 178 then send the customer ID to menu file generation instructions 179.

Instructions 179 use the customer ID to read a particular customer record 158 from customer database 171. Instructions 179 then generate an HTML file 183 that is a menu containing links that allow customer 2 to perform an on-line purchase of a product that was previously purchased by a physical visit to a retail store.

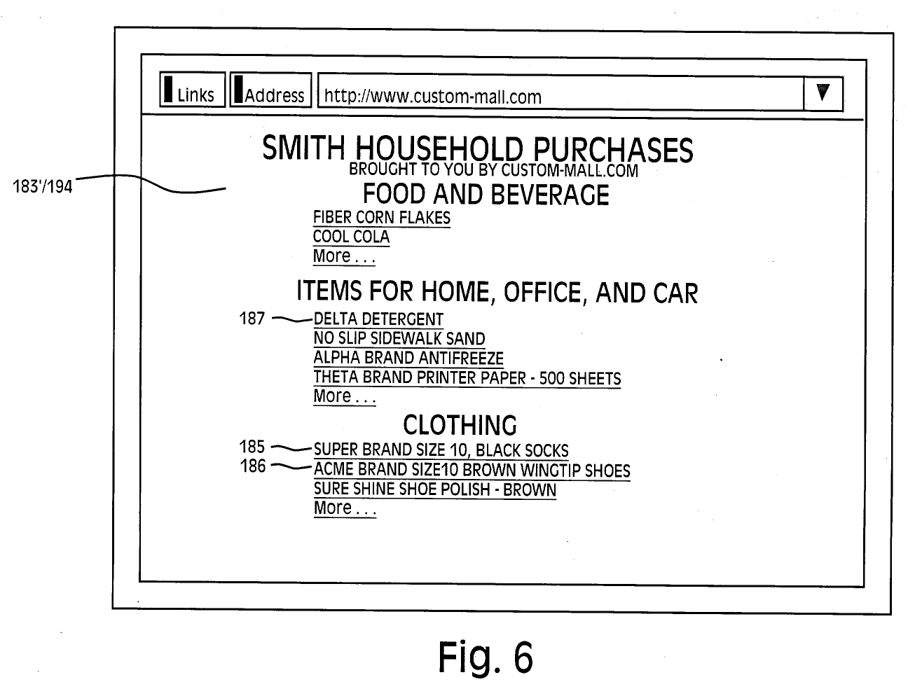

FIG. 6 shows an HTML file display 183′ of the HTML file 183 generated by menu file generation instructions 179. Browser 172 effects display 183′ on CRT 152. To purchase a particular product on-line, consumer 2 selects one of lines 185, 186, or 187 at a particular time, by moving a display cursor to the desired line position using mouse 159, and then clicking a button on mouse 159. Display 183′ includes line 185 informing consumer 2 of the option to perform an on-line purchase of a product previously purchased by a physical visit to a store. More specifically, line 185 informs consumer 2 about the option of performing an on-line purchase transaction for a package 115 of Super brand socks, size 10 black, another package 115 having been previously purchased by a physical visit to store 59.

HTML file 183 has an area, or location, corresponding to line 185 of HTML file display 183′. The area in file 183 corresponding to line 185 stores an Internet direction to computer 22 in site 15, the Universal Product Code of sock package 115, and a code identifying retailer 11. More specifically, the area in file 183 corresponding to line 185 stores the URL “http://custom-mall.com/0 17055 000073/CHOICE.”

In summary, system 1 detects the selection and purchases of a first unit of package 115 by person 2 in store 59, and generates, responsive to this detecting, HTML file 183 representing a plurality of products, including sock package 115. Active area 185 is essentially a type of direction for purchasing a unit of sock package 115. The direction is an invitation to click on area 185 with mouse 159, to send a purchase request, or to request another HTML file from which a purchase request may be sent.

Site 15 sends HTML file 183 to CRT 152. Site 15 then receives, from mouse 159, a request to purchase another unit of package 115. In other words, in FIG. 6, the various active areas 185, 186, and 187 constitute respective directions for purchasing different products. Site 15 receives a signal generated by mouse 159 when mouse 159 indicates an active area corresponding to a particular product.

When user 2 clicks on line 185, browser 172 sends a GET message, which is received by product/retailer ID instructions 180. The GET message includes a product UPC and a retailer ID for the product named on line 185. Generation instructions 181 use the retailer ID to access a particular data structure 175 in retailer database 173. Using a data structure 175, generation instructions 181 generate an HTML file 191 and sends file 191 to browser 172.

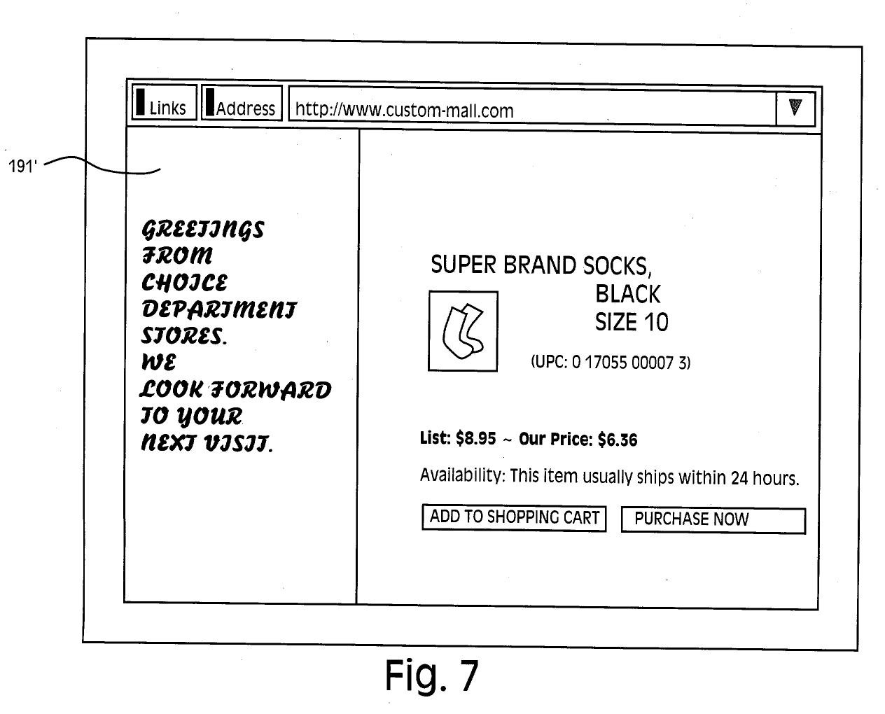

Generation instructions 181 generate an advertisement for the retailer as seen on the left of file display 191′, shown in FIG. 7, of HTML file 191.

In response to receiving a GET message caused by user 2 clicking on the PURCHASE NOW icon in display 191′, product purchase software 182 effects the on-line retailer transaction, and credits an account 23 in structure 175.

In summary, HTML file 183, and the HTML files towards which file 183 link, constitute a type of data structure showing a plurality of products. The presence of some of these products, in the data structure, reflects detection of purchase of these products in a store, while other products shown in the data structure do not reflect such detection. Most of the products reflecting such detection appear before the remaining products, allowing the user to conveniently locate previously purchased products. In other words, the relative position of products in the data structure depends on detecting of product selection and purchase in a retail store.

Retailer 6 includes the ECO grocery store chain. Retailer 6 includes grocery stores 42, 44 and 46. Each of stores 42, 44, and 46 contain products available for purchase, that are not available for purchase in store 59. Computer systems 70 in stores 42, 44 and 46 detect purchases and send a purchase report to site 15, via telecommunications signal paths 30, 32, and 34. Site 15 receives signals from signal paths 30, 32, and 34 to generate a display for home shopping, as described above.

More Detailed Description of the First Preferred Embodiment

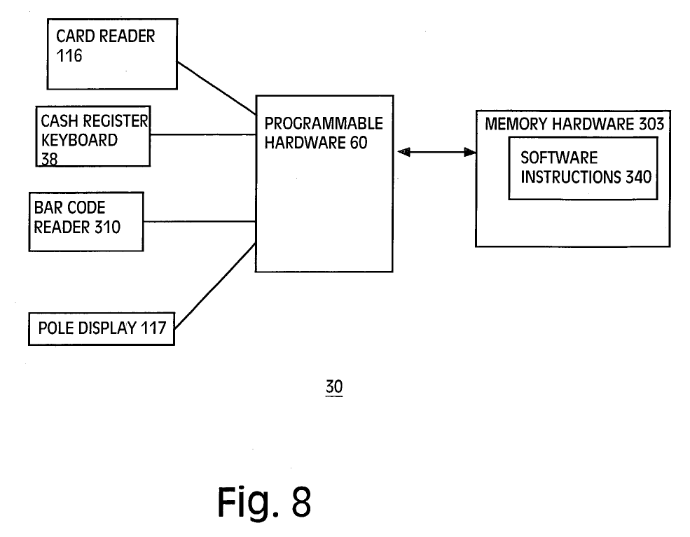

FIG. 8 is a block diagram of checkout station 30. Programmable hardware 60 executes software instructions 340 in memory hardware 303. Cash register keyboard 38 allows manual entry of alpha-numeric data. Bar code reader 310 generates a bar code signal, and sends the bar code signal to hardware 60. Pole display 117 displays product data in response to signals from hardware 60. Hardware 60 and software instructions 340 act to receive consumer identification data from a consumer card, via reader 116.

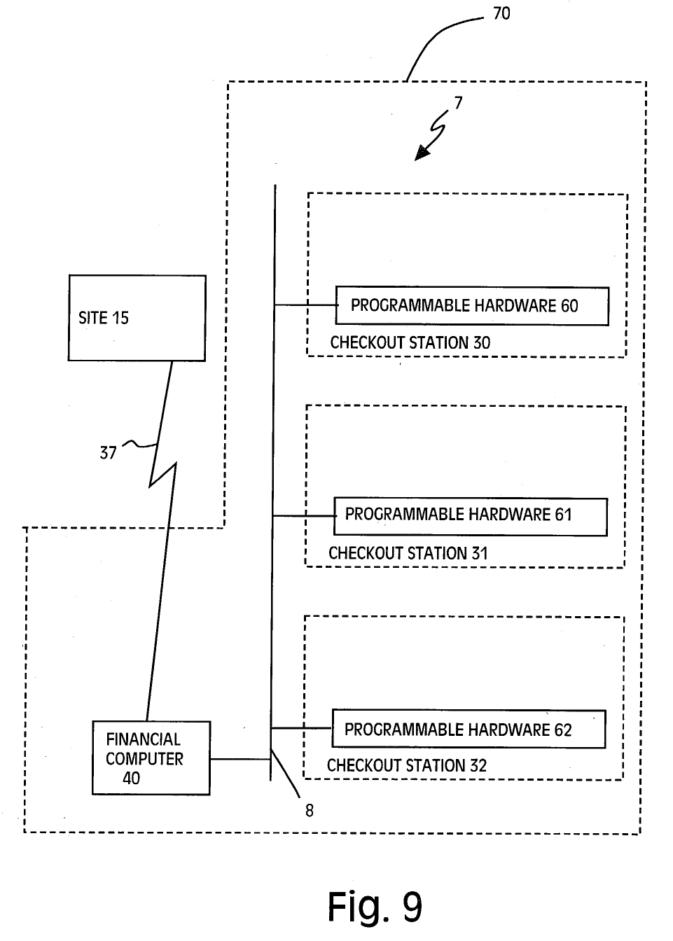

FIG. 9 shows another aspect of the first preferred system. Computer system 70 includes Local Area Network (LAN) 7 in store 59. LAN 7 includes ethernet cable 8 and 4 computers: financial computer 40, hardware 60, hardware 61, and hardware 62. Hardware 60 is in checkout station 30, hardware 61 is in checkout station 31, and hardware 62 is in checkout station 32. Each of computer 40, hardware 60, hardware 61, and hardware 62 has a respective network address uniquely identifying it in network 7. Each of computer 40, hardware 60, hardware 61, and hardware 62 has circuitry for recognizing when a packet containing its address is sent over cable 8, temporarily storing such a packet, and processing the packet contents when such a packet is recognized.

Computer 40, hardware 60, hardware 61, and hardware 62 communicate by sending data packets in a format conforming to the communication protocol of network 7.

System 70 compiles transaction records, including basket data and consumer identification data, from a plurality of checkout transactions, and sends the basket data to site 15, via computer 40, and Wide Area Network (WAN) telecommunications link 37.

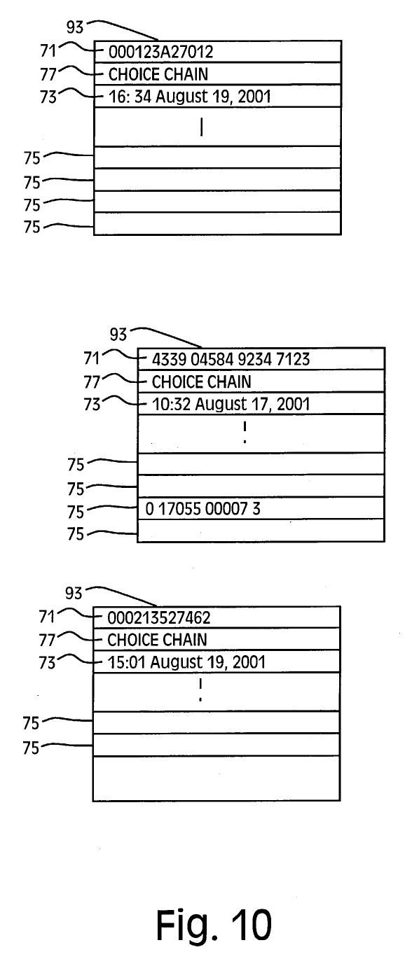

FIG. 10 shows transaction records 93, generated by system 70 and sent from system 70 to site 15 via communication link 37. Each record 93 includes a customer ID field 71, and a list of items 75 selected and purchased by the customer during a checkout transaction. Each field 75 includes the Universal Product Code of the purchased product. Each record 93 includes a company ID field 77, which is essentially a type of data indicating a business entity that performed the retail transaction in which items 75 were sold. Each record 93 also includes a time field 73, indicating the time of day and date that a customer checked out of a retail store.

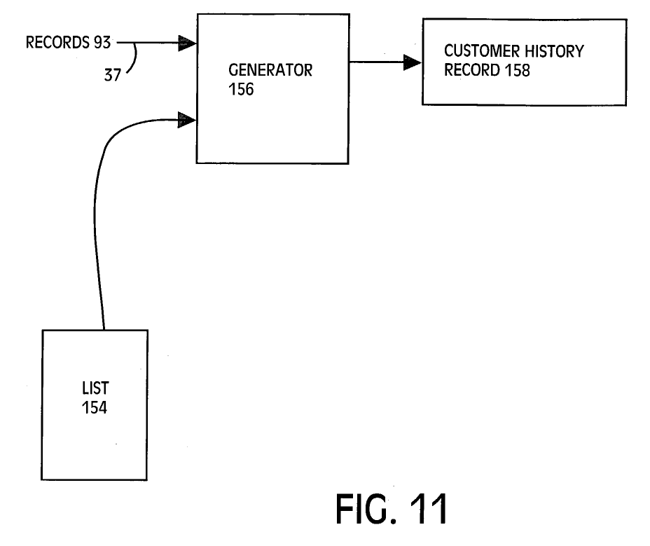

FIG. 11 is a data flow diagram showing a process performed by computer system 22 in site 15. Generator 156 receives transaction records 93, via communication link 37. Generator 156 processes records 93 together with entries in product list 154. Product list 154 includes products that can be purchased on-line. Product list 154 represents each product with a Universal Product Code. Product list 154 is sorted by product code, allowing generator 156 to more efficiently search product list 154. Generator 156 generates, or updates, customer history record 158.

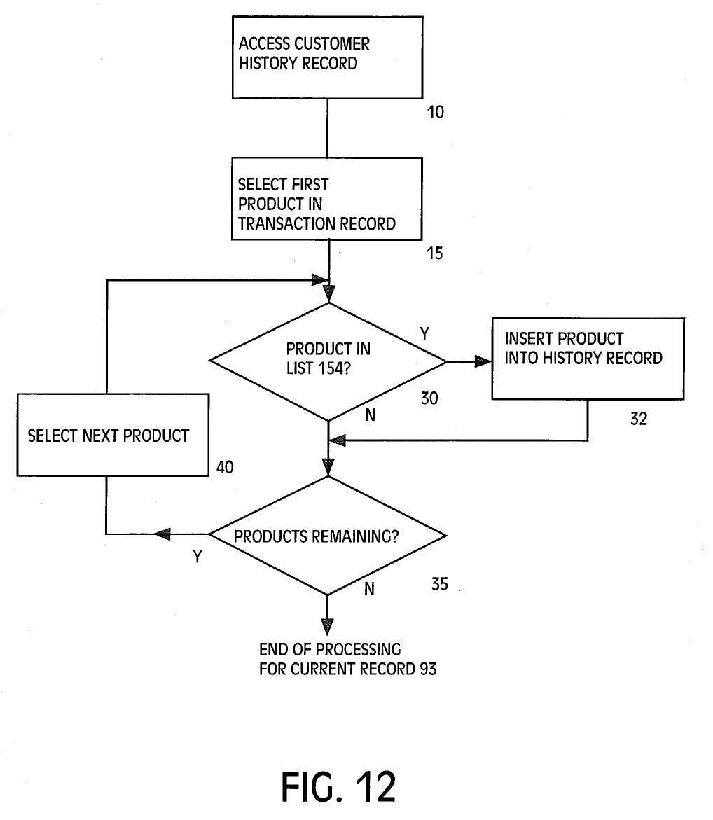

FIG. 12 is a flow chart showing a processing, performed by generator 156, to generate, or update, record 158. Generator 156 reads customer ID field 71 in a record 93. Generator 156 uses the customer ID to read a history record 158 stored in computer system 22. If there is no history record 158 for the customer ID, generator 156 creates a customer history record. Otherwise, generator 156 reads the customer history record 158 that is already stored in computer system 22.

Generator 156 reads the first item 75 in record 93. (step 15). Generator 156 performs a binary search on list 154 to determine if the item 75 is in list 154. (step 30). If the item is in list 154, generator 156 stores the product code of the item into record 158. Generator 156 stores the product code in association with data representing the business entity that performed the retail transaction. Specifically, in step 32 generator 156 stores an item product code 75 in association with identification code 77 from record 93.

If there are products remaining to be processed for the present record 93 (step 35), generator 156 selects the next product 75 (step 40) and processing proceeds to step 30.

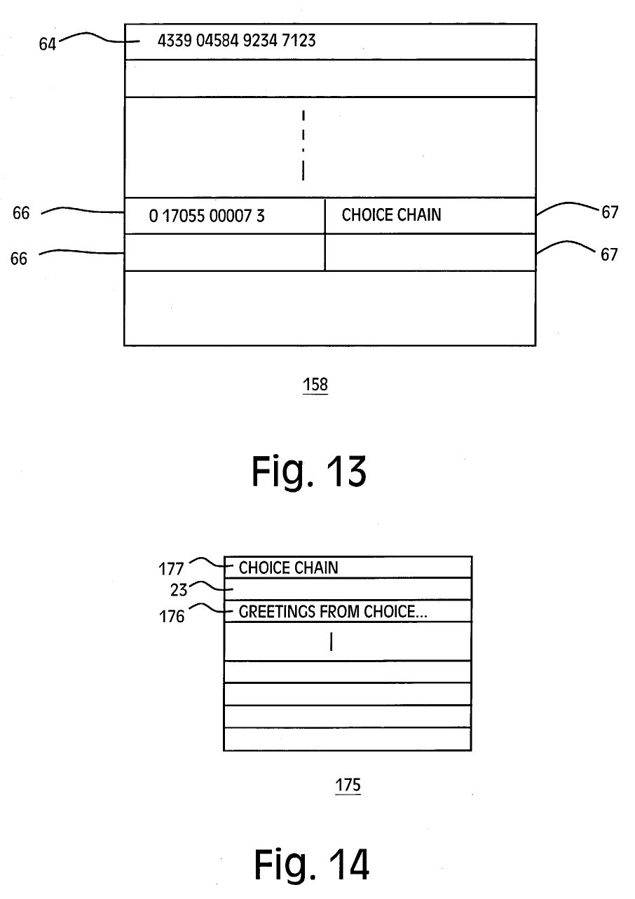

FIG. 13 shows a customer history record 158 in more detail. Record 158 includes customer ID field 64 containing a customer identifier, and field pairs 66-67. In each field pair 66-67, field 66 contains a Universal Product Code and field 67 contains a retailer ID for the product in the corresponding field 66.

FIG. 14 shows a retailer record 175, in retailer database 173, in more detail. Each record 175 includes a retailer ID field 177, an account field 23 that accumulates sales reward data for the retailer identified in field 177, and an advertisement field 176 containing HTML data processed by product file generation instructions 181 to generate an advertisement for the retailer in HTML file 191 (FIG. 5), which is reflected in display 191′ (FIG. 7).

In the first preferred embodiment, circuitry in a checkout station may include multiple CPUs, with one of the CPUs performing price calculation and a different CPU performing most of the processing for compiling and transmitting transaction records. Alternately, in a checkout station may be a single CPU having transaction record processing integrated with conventional UPC product scanning and price lookup. Memory hardware 303 may include two independent memories or may be an integrated memory.

Although in the first preferred system, the basket data goes from a retailer directly to site 15, and site 15 consummates the subsequent on-line transaction with user 2 in home 4, this process could be distributed over more business entities, or more buildings.

Second Preferred Embodiment

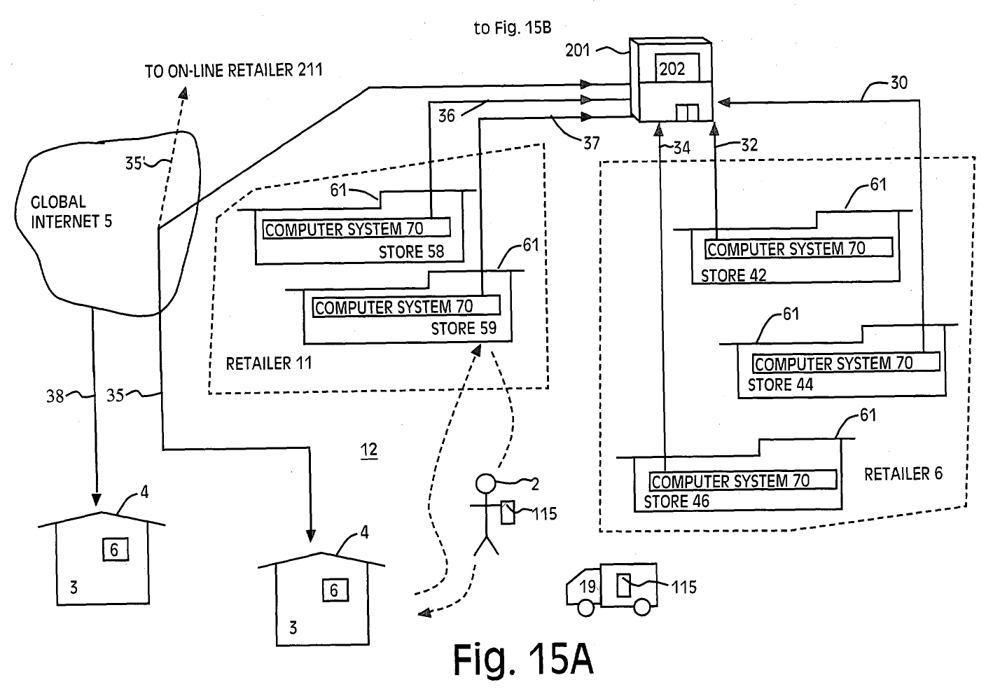

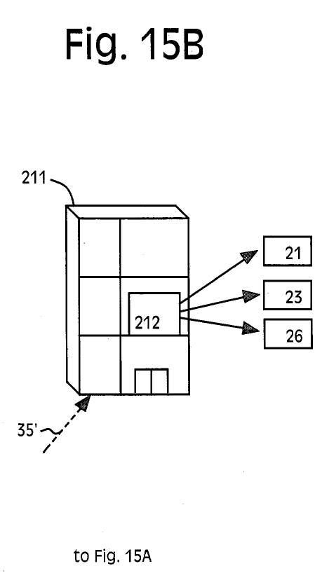

FIGS. 15A and 15B show system 12 in accordance with a second preferred embodiment of the present invention.

Home 3 includes computer system 6 under roof structure 4. Several weeks after visiting store 59, person 2 operates personal computer in home 6. Personal computer 6 acts to receive and display a Hypertext Markup Language (HTML) file from site 201, via Internet 5 and signal path 35. The HTML file includes a menu of products that may be purchased on-line. The menu includes products previously purchased by person 2, including socks package 115.

Person 2 views the HTML file and, in response to this viewing, selects a product for purchase using a mouse or keyboard of computer 6. Selecting the product causes an HTTP message to be sent to site 211 via signal path 35′. Site 211 thus detects this product selection and consummates a purchase transaction with consumer 2 by, for example, processing credit card information for person 2.

Site 211 then generates a signal to ultimately cause personnel to deliver socks package 115 to home 3, via delivery van 19 operated by a private courier service, government mail, or a retailer. Site 211 also adds a fraction of the transaction price to account 23, which is effectively a sales reward owed to retailer 11. In other words, in reliance on signals generated in home 3, site 211 compensates retailer 11 for the on-line purchase of a product, when the on-line purchase was electronically facilitated, or enabled, by a physical visit to a store of retailer 11.

More specifically, to initiate an on-line shopping session, user 2 causes browser 172 to send a document request message to system 202 in site 201 using HTTP. Browser 172 sends an HTTP “GET” message containing the URL “custom-mall.com.” Browser 172 sends this particular URL, “custom-mall.com,” in response to user 2 typing in this URL using keyboard 161, or selecting a particular bookmark using mouse 159.

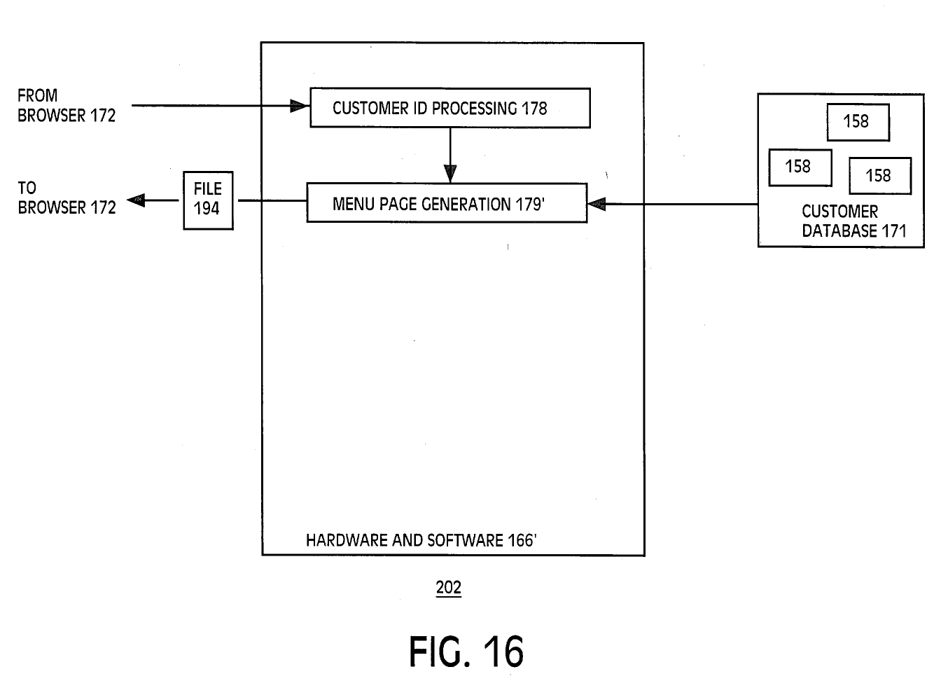

FIG. 16 is a data flow diagram showing a process performed in computer system 202 in site 201. In response to the GET message, customer ID processing instructions 178 obtain a customer ID. Instructions 178 then send the customer ID to menu file generation instructions 179′.

Instructions 179′ use the customer ID to read a particular customer record 158 from customer database 171. Instructions 179 then generate an HTML file 194 that is a menu containing links that allow customer 2 to perform an on-line purchase of a product that was previously purchased by a physical visit to a retail store. Some of these links are directed to on-line purchase sites acting on behalf of a different business entity than the business entity that owns site 201.

Although the content of HTML file 194 is different than that of HTML file 183, when browser 172 effects display of HTML file 194, the display is similar, or identical, to file display 183′ shown in FIG. 6.

HTML file 194 has an area, or location, corresponding to line 185 of HTML file display 183′. The area in file 194 corresponding to line 185 stores an Internet direction to computer 212 in site 211, the Universal Product Code of sock package 115, a code identifying retailer 11, and an internet direction to computer 22 in site 15. More specifically, the area in file 194 corresponding to line 185 stores the URL “http://www.super-online.com/017055000073/CHOICE/www.custom-mall.com.”

In summary, system 12 detects the selection and purchases of a first unit of package 115 by person 2 in store 59, and generates, responsive to this detecting, HTML file 194 representing a plurality of products, including sock package 115. Active area 185 is essentially a type of direction for purchasing a unit of sock package 115. The direction is an invitation to click on area 185 with mouse 159, to send a purchase request, or to request another HTML file from which a purchase request may be sent.

Site 201 sends HTML file 194 to CRT 152. Site 211 then receives, from mouse 159, a request to purchase another unit of package 115. In other words, in FIG. 6, the various active areas 185, 186, and 187 constitute respective directions for purchasing different products. Site 211 receives a signal generated by mouse 159 when mouse 159 indicates line 185.

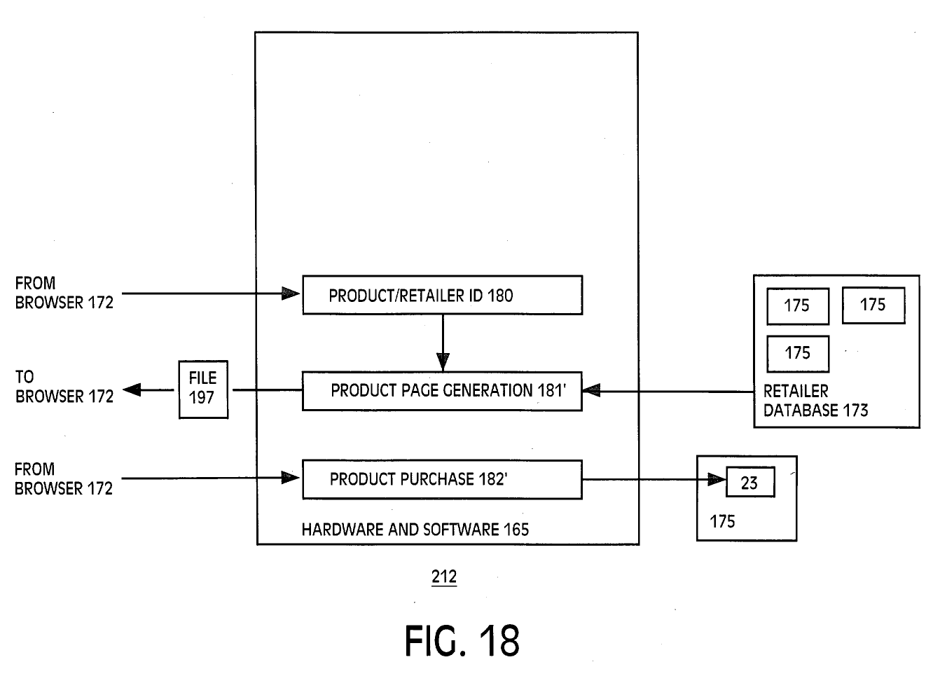

FIG. 18 is a data flow diagram showing a process performed in computer system 212 in site 211. When user 2 clicks on line 185, browser 172 sends a GET message, which is received by product/retailer ID instructions 180. The GET message includes a product UPC and a retailer ID for the product named on line 185. Generation instructions 181′ use the retailer ID to access a particular data structure 175 in retailer database 173. Using a data structure 175, generation instructions 181′ generate an HTML file 197 and sends file 197 to browser 172.

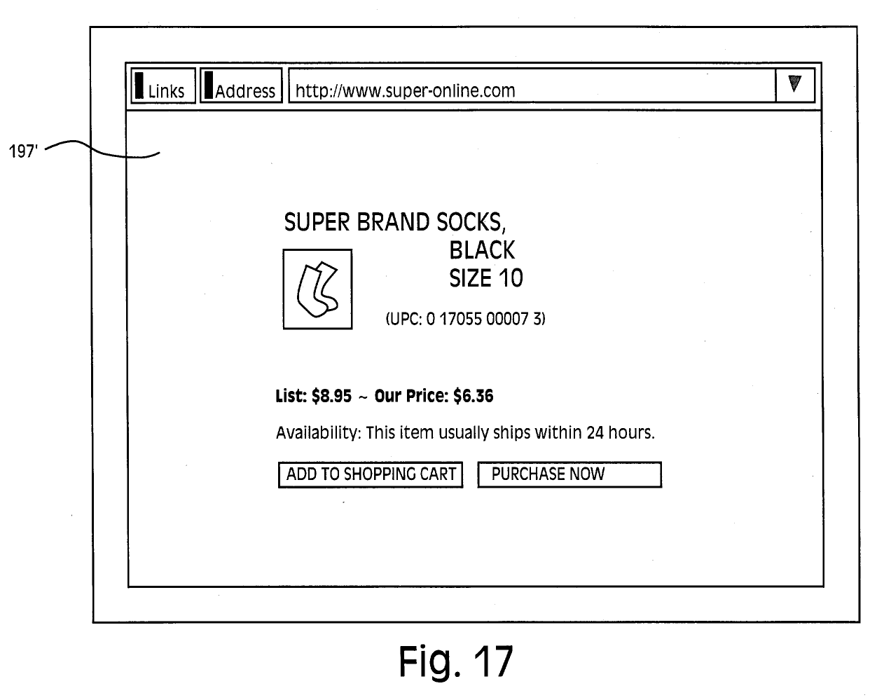

FIG. 17 shows display 197′ generated by browser 172 in response to receiving file 197.

In response to receiving a GET message caused by user 2 clicking on the PURCHASE NOW icon in display 197′, product purchase software 182′ effects the on-line retailer transaction, and credits an account 23 in structure 175.

In summary, HTML file 194, and the HTML files towards which file 194 link, constitute a type of data structure showing a plurality of products. The presence of some of these products, in the data structure, reflects detection of purchase of these products in a store, while other products shown in the data structure do not reflect such detection. Most of the products reflecting such detection appear before the remaining products, allowing the user to conveniently locate previously purchased products. In other words, the relative position of products in the data structure depends on detecting of product selection and purchase in a retail store.

Third Preferred Embodiment

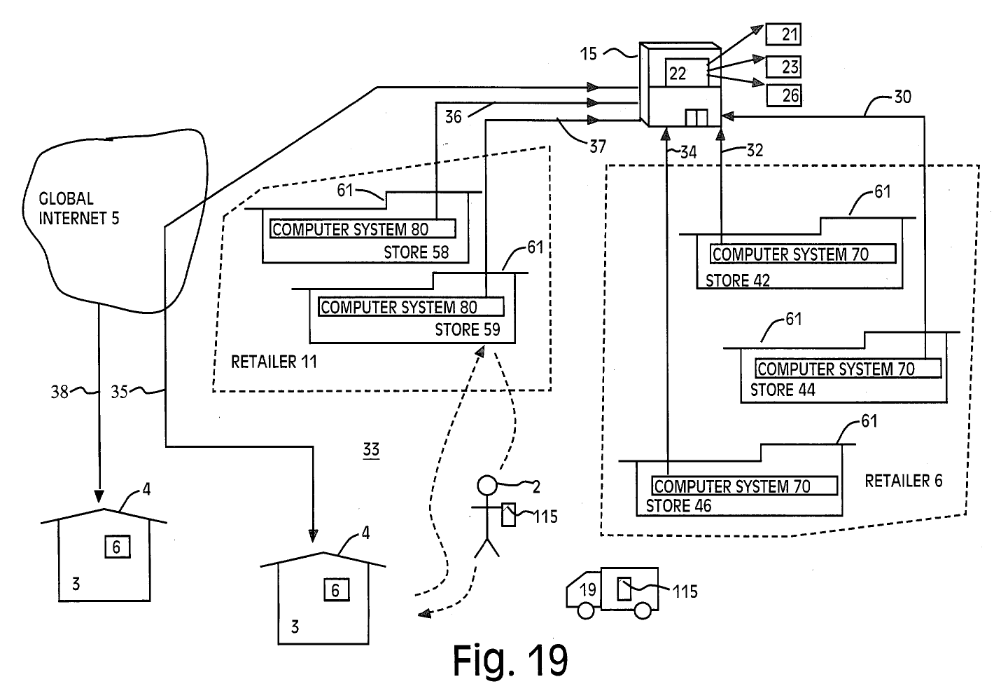

FIG. 19 shows system 33 in accordance with a third preferred embodiment of the present invention. Store 59 includes computer system 80 under roof structure 61. Computer system 80 in store 59 detects the purchase of socks package 115 by person 2, and sends purchase data identifying the purchase to site 15.

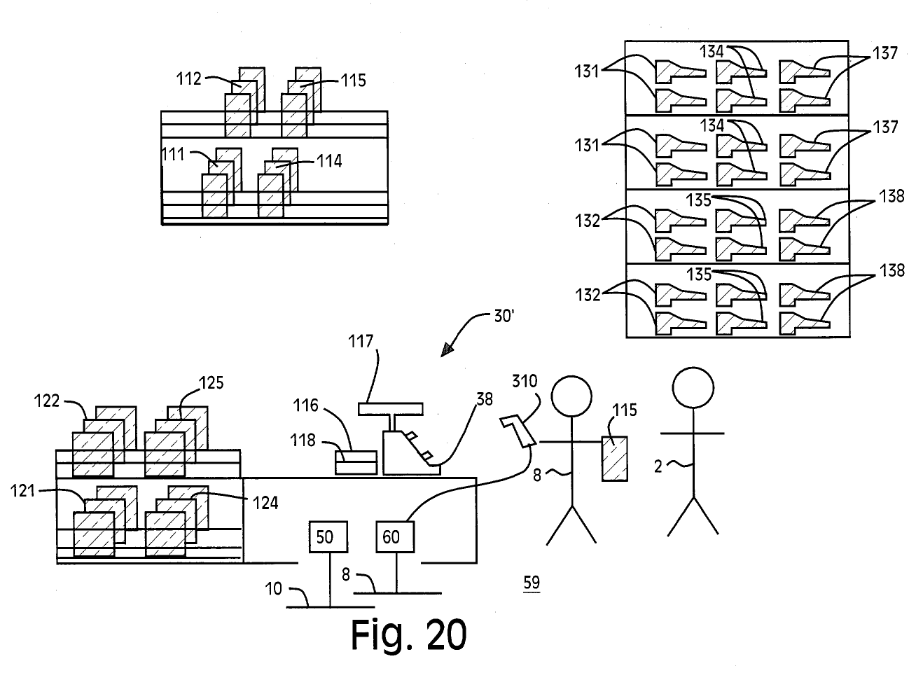

FIG. 20 shows checkout station 30′ in store 59. Consumer 2 selects a product such as sock package 115 and gives sock package 115 to salesperson 8. Consumer 2 may present a card for insertion into interface slot 118 of card reader 116. Salesperson 8 scans each selected product using bar code reader 310, or enters the product selection information manually via keyboard 38, allowing checkout station 30′ to generate a Universal Product Code for each selected product. Thus, station 30′ determines the amount due from consumer 117, and displays the amount due via pole display 117. System 50, in station 30′, sends the Universal Product Code over network cable 10, allowing another computer in store 59 to send a record of the transaction to site 15 via signal path 37.

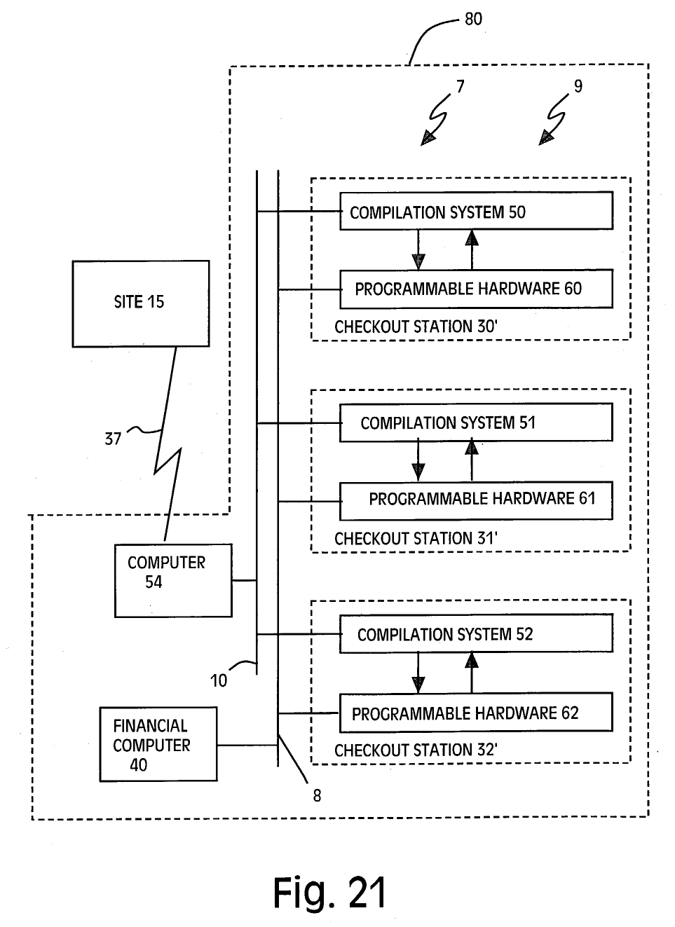

FIG. 21 shows another aspect of the third preferred system. Computer system 80 includes Local Area Network (LAN) 7 in store 59. LAN 7 includes ethernet cable 8 and 4 computers: financial computer 40, programmable hardware 60, programmable hardware 61, and programmable hardware 62. Hardware 60 is in checkout station 30′, hardware 61 is in checkout station 31′, and hardware 62 is in checkout station 32′. Each of computer 40, hardware 60, hardware 61, and hardware 62 has a respective network address uniquely identifying it in network 7. Each of computer 40, hardware 60, hardware 61, and hardware 62 has circuitry for recognizing when a packet containing its address is sent over cable 8, temporarily storing such a packet, and processing the packet contents when such a packet is recognized. Using the protocol of network 7, financial computer 40 sends product pricing information to hardware 60, hardware 61, and hardware 62.

LAN 9 includes cable 10 and 4 computers: computer 54, compilation system 50, compilation system 51, and compilation system 52. System 50 is in checkout station 30′, system 51 is in checkout station 31′, and system 52 is in checkout station 32′. Each of computer 54 and systems 50, 51, and 52 has a respective network address uniquely identifying it in network 9. Each of computer 54 and systems 50, 51, and 52 has circuitry for recognizing when a packet containing its address is sent over cable 10, temporarily storing such a packet, and processing the packet contents when such a packet is recognized. Thus, computer 54 communicates with systems 50, 51, and 52 by sending data packets in a format conforming to the communication protocol of network 9.

Computers 54 and systems 50, 51, and 52 compile records 93, including basket data and consumer identification data from a plurality of checkout transactions, and sends the basket data to site 15, via Wide Area Network (WAN) telecommunications link 37.

Thus, a single scan by barcode reader 310 serves the dual purpose of calculating a price for a product and sending a transaction record to site 15 via signal path 37.

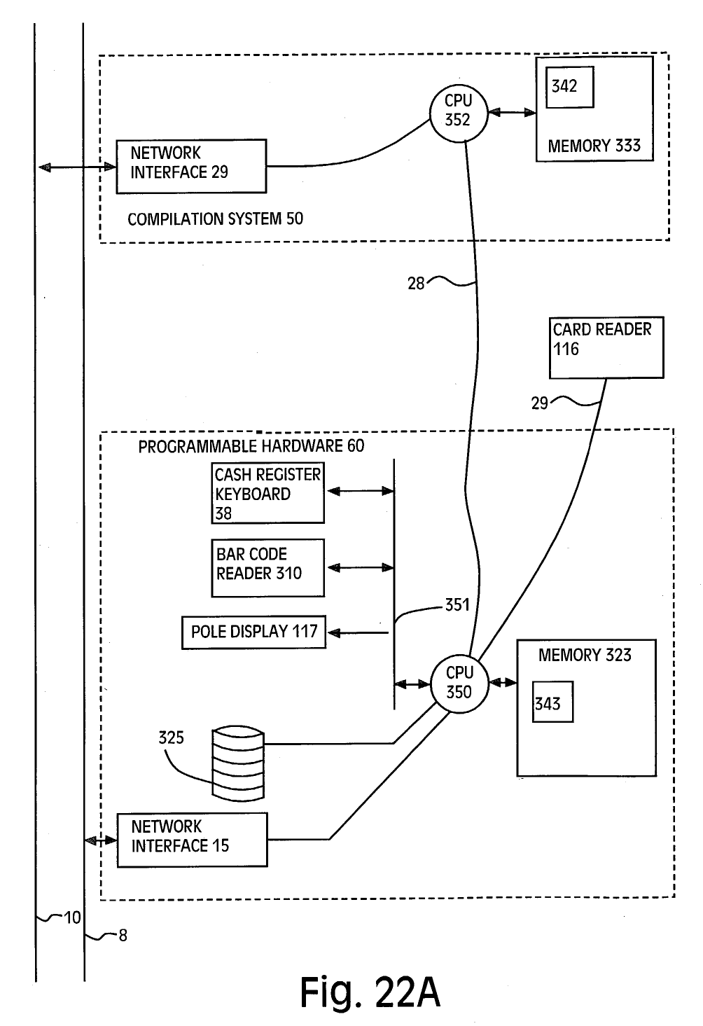

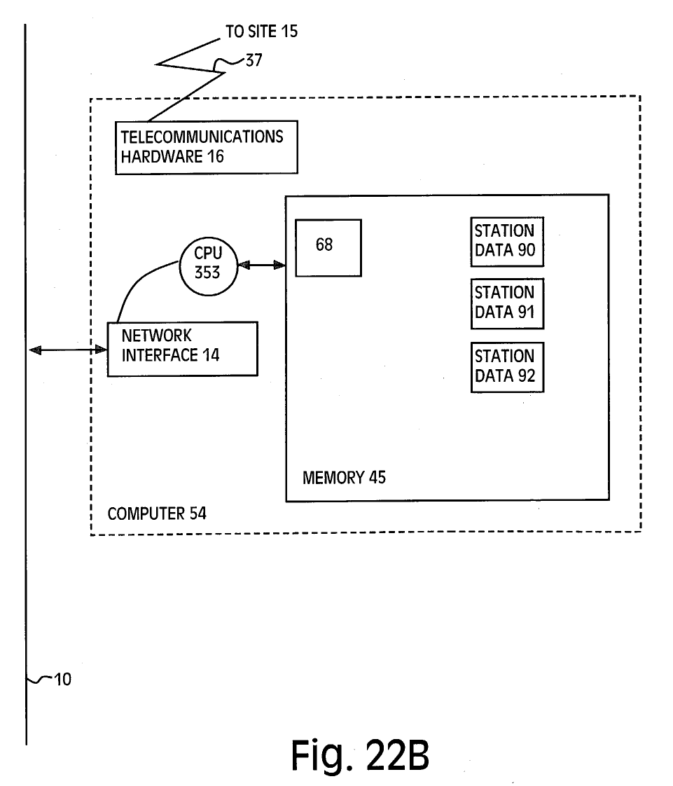

FIGS. 22A and 22B are a block diagram of computer 54 and checkout station 30′. Checkout station 30′ includes hardware 60 and data compilation system 50. Data compilation system 50 communicates with hardware 60 via serial data cable 28. Hardware 60 includes an IBM 4680-4690 Point of Sale System. CPU 350 executes instructions 343 in random access, addressable memory 323. CPU 350 communicates with cash register keyboard 38, bar code reader 310, and pole display 117 via RS-485 serial bus 351. CPU 350 send data to, and receives data from cable 8 via network interface 15. Cash register keyboard 38 allows manual entry of alpha-numeric-data. Bar code reader 310 generates a bar code signal, and sends the bar code signal to CPU 350. Poll display 317 displays product data in response to signals from CPU 350. Disk 325 provides long term storage.

In system 50, CPU 352 executes program 342 in random access, addressable memory 333. CPU 352 send data to, and receives data from cable 10 via network interface 29.

A physical layer includes an RS-232 asynchronous serial connection on which CPU 350 communicates with CPU 352 via RS232 line 28.

A data link layer between system 50 and hardware 60 includes a frame with a start code octet, one or more data octets, a checksum octet, and an end code octet. Every frame transmitted requires an ACK/NAK response. When system 50 receives a frame with a correct checksum, system 50 sends an ACK response; otherwise system 50 sends a NAK response. If hardware 60 does not receive a response within a reasonable amount of time, hardware 60 declares a timeout condition and resend the frame.

An application layer between system 50 and hardware 60 includes a series of commands and responses, as discussed in more detail below.

Table 1 below summarizes an Item Committed command sent from hardware 60 to system 50 in the application layer supported by the data link layer, which in turn is supported by the physical layer. Parameters for the Item Committed command include:

TABLE 1

| | |
|---|---|
| P0 | Sales type |
| | 0x30 = Normal Sales |
| | 0x31 = Refund/Return |
| | 0x34 = Cancel Normal Sales |
| | 0x35 = Cancel Refund/Return |
| P1 | UPC product code, (12 digits, packed decimal). |

It is presently preferred that sending of commands from hardware 60 be implemented by customizing hardware 60 with a “user exits,” which are a standardized mechanism by which the IBM 4860-4690 system calls custom routines, as described in the IBM 4680-4690 Supermarket Application: Programming Guide, SC30-3634, Third Edition (January 1997). Some exits employed in this customization may include TSUPEC2—After a Customer Checkout Transaction is Completed, and TSUPEC14—After Reading the Keyboard/Scanner, and TSUPEC23—Before Writing a Line to the Display.

Checkout stations 31′ and 32′ each have the same circuitry as that of as checkout station 30′.

When system 50 receives an application layer command from hardware 60, system 50 sends the command to computer 54. In response to receiving a command, computer 54 sends any needed response to system 50, and system 50 then sends the response to hardware 60.

During a checkout transaction for a customer at station 30′, computer 54 maintains station data 90. Station data 90 includes data about transactions at checkout station 30′, including a list of products selected by the customer, and identification data for the customer.

During the checkout transaction for a customer at station 31′, computer 54 maintains station data 91. Station data 91 includes data about transactions at checkout station 31′, including a list of products selected by the customer, and identification data for the customer.

During the checkout transaction for a customer at station 32′, computer 54 maintains station data 92. Station data 92 includes data about transactions at checkout station 32′, including a list of products selected by the customer, and identification data for the customer.

In computer 54, CPU 353 executes instructions 68 in random access, addressable memory 45. CPU 353 sends data to, and receives data from, cable 10 via network interface 14.

When computer 54 receives an Item Committed command identifying a product selected by a customer at station 30′, computer 54 adds the product to a basket list in station data 90, to build a record 93.

Computer 54 sends records 93 to site 15.

Fourth Preferred Embodiment

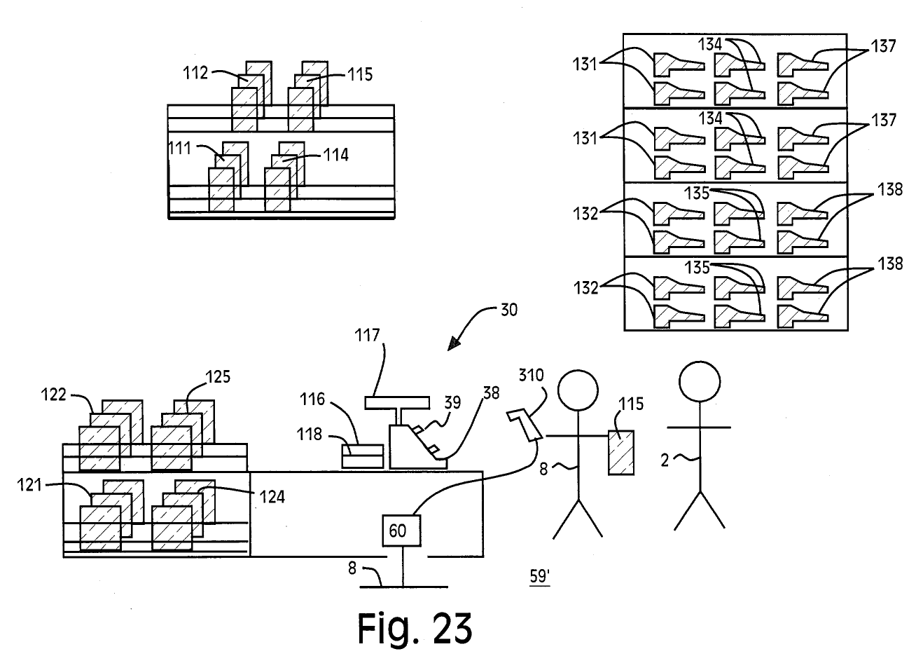

FIG. 23 shows retail department store 59′ in accordance with a fourth preferred embodiment of the present invention.

Consumer 2 selects a product such as sock package 115 and gives sock package 115 to salesperson 8. Consumer 2 may present a card for insertion into interface slot 118 of card reader 116. Salesperson 8 scans each selected product using bar code reader 310, or enters the product selection information manually via keyboard 38, allowing checkout station 30 to generate a Universal Product Code for each selected product. Thus, station 30 determines the amount due from consumer 2, and displays the amount due via pole display 117. Depending on whether sales person 8 activates key 39 on keyboard 38, station circuitry 60 also sends the Universal Product Code over network cable 8, allowing another computer in store 59 to send a record of the transaction to site 15 via signal path 37. If sales person 8 does not activate key 39, station circuitry 60 sends the transaction record on signal path 37, as described above in connection with the first embodiment. If sales person 8 does activate key 39, station circuitry 60 is inhibited from sending the transaction record on signal path 37. Thus, consumer 2 may instruct salesperson 8 to inhibit the processing of certain transactions for the home menu of consumer 2. Consumer 2 may make such a decision based on privacy concerns, or a judgement that the item being purchased will be unlikely to be purchased again.

The fourth preferred system features an alternate mechanism for allowing the consumer to prevent certain items from appearing on the home menu as described in more detail below.

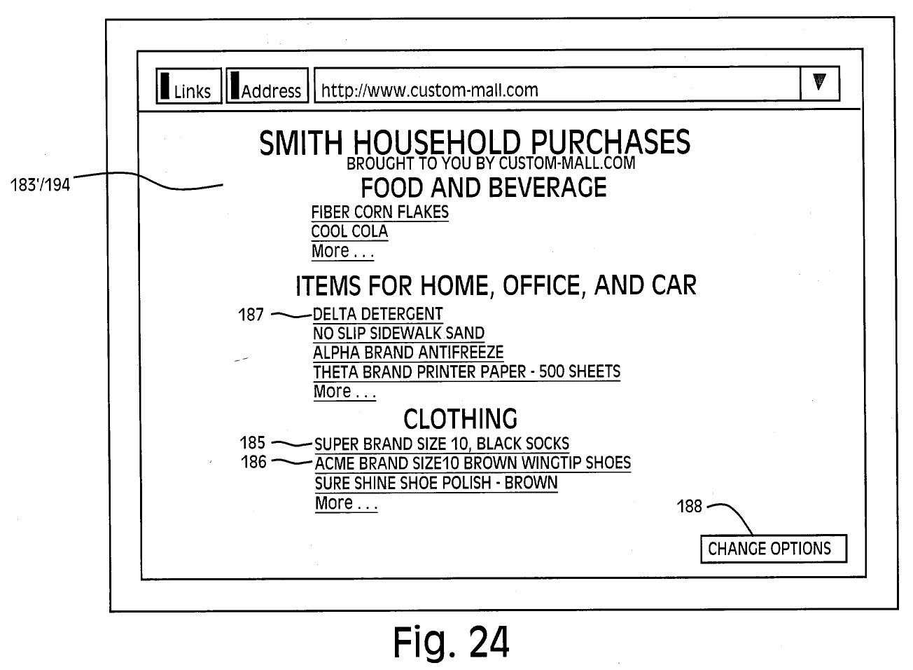

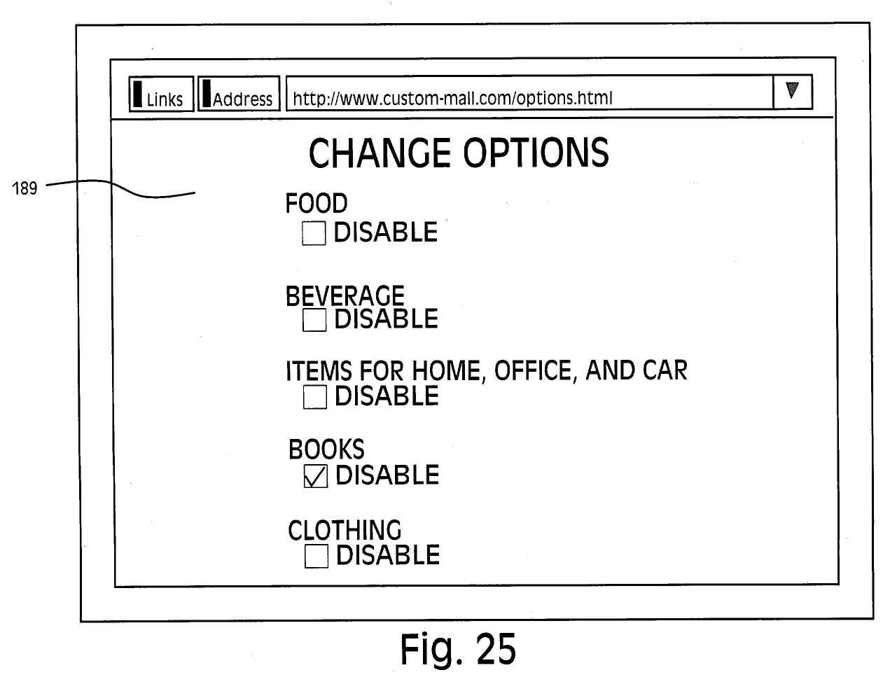

FIG. 24 shows an HTML file display 183″ of the HTML file 183′ generated by menu file generation instructions 179′. Browser 172 effects display 183″ on CRT 152. To restrict the types of items that appear on the home menu, consumer 2 selects button 188, causing site 15 to send an HTML file (“options.html”) to CRT152, resulting in display 189 shown in FIG. 25.

As shown in FIG. 25, the consumer may prevent automatic compilation of a category of items by selecting the “disable” box under the category for which the consumer does not wish items to appear on the home menu.

More Detailed Description of the Fourth Preferred Embodiment

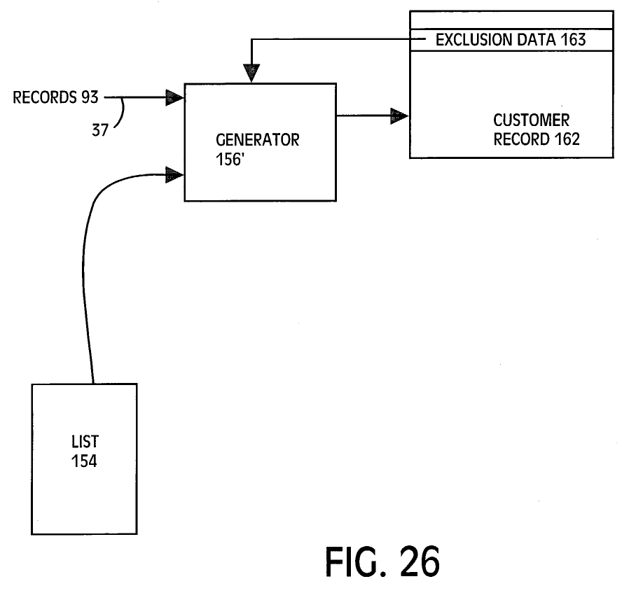

FIG. 26 is a data flow diagram showing a process performed by computer system 22′ in site 15′. Generator 156′ receives transaction records 93, via communication link 37. Generator 156 processes records 93 together with entries in product list 154 and exclusion data 163 in customer record 162. Exclusion data 163 was generated in response to the customer selecting one or more disable boxes in screen 189 (FIG. 25).

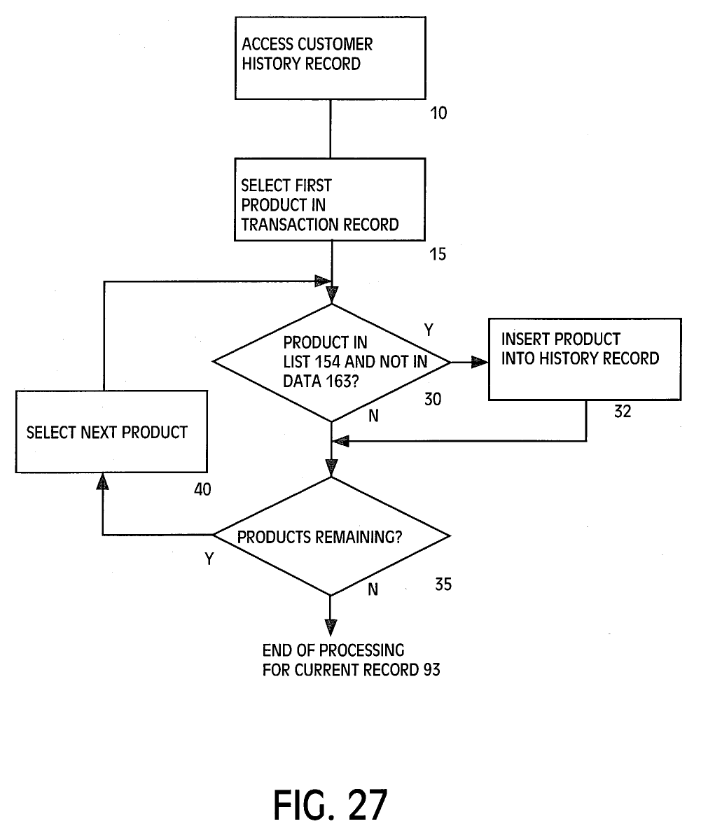

FIG. 27 is a flow chart showing a processing, performed by generator 156′, to generate, or update, record 162. Generator 156′ reads customer ID field 71 in a record 93. Generator 156′ uses the customer ID to read a customer record 162 stored in computer system 22′. If there is no record 162 for the customer ID, generator 156′ creates a customer record 162. Otherwise, generator 156′ reads the customer record 162 that is already stored in computer system 22′.

Generator 156′ reads the first item 75 in record 93. (step 15). Generator 156′ performs a binary search on list 154 to determine if the item 75 is in list 154. (step 30). If the item is in list 154 and is not an exclusion data 163 of record 162, generator 156′ stores the product code of the item into record 162. Generator 156′ stores the product code in association with data representing the business entity that performed the retail transaction. Specifically, in step 32 generator 156′ stores an item product code 75 in association with identification code 77 from record 93.

If there are products remaining to be processed for the present record 93 (step 35), generator 156′ selects the next product 75 (step 40) and processing proceeds to step 30.

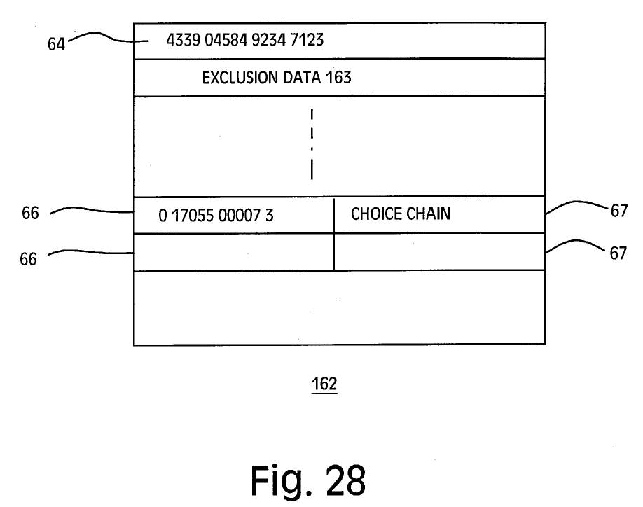

FIG. 28 shows a customer record 162 in more detail. Record 162 includes customer ID field 64 containing a customer identifier, exclusion date 163, and field pairs 66-67. Exclusion data 163 may take the form of a list of universal product codes, a pointer to a list of universal product codes, or some other data to designate a class of products.

Benefits, other advantages, and solutions have been described above with regard to specific examples. The benefits, advantages, solutions, and any element(s) that may cause any benefit, advantage, or solution to occur or become more pronounced are not critical, required, or essential feature or element of any of the claims.

Thus, the exemplary systems provide a personalized on-line shopping service accessible outside of a store, from a conventional personal computer (PC) in a home or office, or a handset mobile device, for example. A menu features products previously purchased in a visit to a store. The product menu may encompass a variety of stores and product types, including food, clothing, and home supplies. The product menu may be populated solely by this store-collected purchase history. Alternately, the product menu may be prioritized by this store-collected purchase history, allowing on-line purchase of products that are new to the consumer, as well as of previously purchased products.

The system is particularly advantageous for those products that may be replenished or replaced after a previous store visit and purchase has confirmed product suitability. The user may easily buy a favorite product from home, or while traveling, without having to search for a product purchase page within the enormous Internet space.

Benefits, other advantages, and solutions have been described above with regard to specific examples. The described benefits, advantages, solutions, and any element(s) that may cause any benefit, advantage, or solution to occur or become more pronounced are not critical, required, or essential feature or element of the invention.

Additional advantages and modifications will readily occur to those skilled in the art. The invention in its broader aspects is not limited to the specific details, representative apparatus, and illustrative examples shown and described. Accordingly, departures may be made from such details without departing from the spirit or the scope of Applicants' general inventive concept. The invention is defined in the following claims. In general, the words “first,” “second,” etc., employed in the claims do not necessarily denote an order.

What is claimed is:

1. In a system including a first building, and an interface including an output device, a method comprising:
detecting selection of a first instance of a first item by a first person in the first building; and
generating, responsive to the detecting step, a first signal for display by the output device at a time when the output device is displaced from the first building, the first signal representing a plurality of items, including the first item, with respective directions for purchasing the items.

2. The method of claim 1 further including inhibiting the generating step for a selected item.

3. The method of claim 1 further including inhibiting the generating step for a selected item, responsive to a signal generated by a user control in the first building.

4. The method of claim 1 wherein the interface further includes an input device and the method further includes
inhibiting the generating step for a selected item, responsive to a signal generated by the input device, at a time when the input device is displaced from the first building.

5. The method of claim 4 wherein the input device is in a second building.

6. The method of claim 1 further including sending the first signal to the output device.

7. The method of claim 1 further including sending the first signal to the output device at a time when the output device is displaced from the first building.

8. The method of claim 1 wherein the interface further includes an input device and the method further includes
receiving, from the input device, a request to purchase a second instance of the first item, the receiving being performed at a time when the input device is displaced from the first building.

9. The method of claim 8 wherein the receiving is performed at a time when the input device is in a second building.

10. The method of claim 9 wherein the first person resides in the second building.

11. The method of claim 9 wherein the interface is in a mobile hand set device.

12. The method of claim 8 wherein the input device includes a pointing device, the respective directions are positions on the output device, and receiving includes
receiving a signal generated when the pointing device indicates a position corresponding to the first item.

13. The method of claim 8 further including crediting an entity associated with the first building, responsive to receiving the request.

14. The method of claim 1 wherein the first item is represented at a position depending on the detecting step.

15. The method of claim 1 further including displaying an advertisement for an entity associated with the first building.

16. The method of claim 1 wherein the system further includes a second building, and the method further includes
detecting selection of a first instance of a second item in the second building;
generating, responsive to the previous step, the first signal to include the second item.

17. The method of claim 16 wherein the second item is not available for purchase in the first building.

18. The method of claim 17 wherein the first item is not available for purchase in the second building.

19. The method of claim 1 wherein the method further includes
generating, responsive to the detecting step, the first signal to include an item different from and related to the first item.

20. The method of claim 1 further including determining an amount due responsive to the detecting selection of a first instance.

21. The method of claim 1 wherein the first instance of the item includes a code identifying a first company, and detecting selection of a first instance includes detecting the code with an electromagnetic detector.

22. The method of claim 21 wherein the code is different from corresponding codes for items having a different color and being otherwise substantially the same as the first item.

23. The method of claim 21 wherein the code is different from a code of another item having a different size and being otherwise substantially the same as the first item.

24. The method of claim 1 further including
causing delivery of the second instance to a home, responsive to receiving the request.

25. The method of claim 1 further including carrying the first instance from the store, the carrying being performed by the first person.

26. In a system including a first building, and an interface including an output device, a processing system comprising:
a generator, responsive to detecting selection of a first instance of a first item by a first person in the first building, that generates a first signal for display by the output device at a time when the output device is displaced from the first building, the first signal representing a plurality of items, including the first item, with respective directions for purchasing the items.

27. The processing system of claim 26 further including a sender that sends the first signal to the output device.

28. The processing system of claim 26 further including a sender that sends the first signal to the output device at a time when the output device is displaced from the first building.

29. The processing system of claim 26 wherein the interface further includes an input device and the processing system further includes
an order fulfillment unit that receives, from the input device, a request to purchase a second instance of the first item, the receiving being performed at a time when the input device is displaced from the first building.

30. The processing system of claim 29 wherein the receiving is performed at a time when the input device is in a second building.

31. The processing system of claim 30 wherein the first person resides in the second building.

32. The processing system of claim 29 wherein the interface is in a mobile hand set device.

33. The processing system of claim 29 wherein the input device includes a pointing device, the respective directions are positions on the output device, and receiving includes
receiving a signal generated when the pointing device indicates a position corresponding to the first item.

34. The processing system of claim 29 further including a memory area for storing information about crediting an entity associated with the first building, responsive to receiving the request.

35. The processing system of claim 26 wherein the first item is represented at a position depending on the detecting.

36 The processing system of claim 26 further including a memory area for storing information about displaying an advertisement for an entity associated with the first building.

37. The processing system of claim 26 wherein the system further includes a second building, and the processing system further includes
detecting selection of a first instance of a second item in the second building, and the generator is also responsive to detecting selection of a first instance of a second item in the second building, to generate the first signal to include the second item.

38. The processing system of claim 37 wherein the second item is not available for purchase in the first building.

39. The processing system of claim 38 wherein the first item is not available for purchase in the second building.

40. The processing system of claim 26 wherein the generator includes circuitry to generate the first signal to include an item different from and related to the first item.

41. The processing system of claim 26 further including a detector that detects selection of the first instance and determines an amount due responsive to the detecting selection of the first instance.

42. The processing system of claim 41 wherein the first instance of the item includes a code identifying a first company, and the detector includes an electromagnetic detector.

43. The processing system of claim 42 wherein the code is different from corresponding codes for items having a different color and being otherwise substantially the same as the first item.

44. The processing system of claim 37 wherein the code is different from a code of another item having a different size and being otherwise substantially the same as the first item.

45. The processing system of claim 29 further including
a unit that causes delivery of the second instance to a home, responsive to receiving the request.

46. In a system including a first building, and an interface including an output device, a processing system comprising:
means for detecting selection of a first instance of a first item by a first person in the first building; and
means for generating, responsive to the detecting step, a first signal for display by the output device at a time when the output device is displaced from the first building, the first signal representing a plurality of items, including the first item, with respective directions for purchasing the items.

47. The processing system of claim 46 further including means for sending the first signal to the output device.

48. The processing system of claim 46 further including means for sending the first signal to the output device at a time when the output device is displaced from the first building.

49. The processing system of claim 46 wherein the interface further includes an input device and the processing system further includes
means for receiving, from the input device, a request to purchase a second instance of the first item, the receiving being performed at a time when the input device is displaced from the first building.
